(19) United States
(12) Patent Application Publication
(10) Pub. No.: US 2023/0043723 A1
(43) Pub. Date: Feb. 9, 2023

(54) ELECTROSTATIC DISCHARGE (ESD) CIRCUIT AND METHOD TO PROTECT INTERNAL CIRCUIT FROM ESD CURRENT

(71) Applicant: United Microelectronics Corp., Hsinchu (TW)

(72) Inventors: Chih-Yuan Chung, Hsinchu City (TW); Te-Chang Wu, Hsinchu County (TW)

(73) Assignee: United Microelectronics Corp., Hsinchu (TW)

(21) Appl. No.: 17/970,590

(22) Filed: Oct. 21, 2022

Related U.S. Application Data
(62) Division of application No. 17/223,767, filed on Apr. 6, 2021.

(51) Int. Cl. H02H 3/08; H02H 3/06

(52) U.S. Cl. CPC H02H 3/08; H02H 3/06

(57) ABSTRACT

An electrostatic discharge (ESD) circuit is used to protect an internal circuit. The ESD circuit includes: an ESD clamp, having a first terminal connected to a power and a second terminal connected to a ground voltage; and a first switch, connected between an ESD terminal of the ESD clamp and the internal circuit. A gate of the first switch is controlled by a state signal in the ESD clamp to turn off the first switch when an ESD event occurs on the first terminal of the ESD clamp and turn on the first switch when the ESD event does not occur.

### CROSS-REFERENCE TO RELATED APPLICATION

This application is a divisional application of and claims the priority benefit of U.S. application Ser. No. 17/223,767, filed on Apr. 6, 2021, now pending. The entirety of the above-mentioned patent application is hereby incorporated by reference herein and made a part of this specification.

### BACKGROUND OF THE INVENTION

### Field of the Invention

The invention relates to technology to electrostatic discharge (ESD) protection and to ESD circuit and method to protect an internal circuit from ESD current.

### Description of Related Art

Electrostatic discharge (ESD) may easily damage IC devices such as DRAMs and SRAMs during both manufacture and operation. A person walking on a carpet, for instance, can carry up to several thousand volts of electrostatic charge under high relative humidity (RH) conditions and over 10,000 volts under low RH conditions. If such a person touches an IC package, the electrostatic charge on his/her body is instantly discharged to the IC package, thus causing ESD damage to the internal circuitry of the IC package. A widely used solution to this problem is to provide an on-chip ESD protection circuit around each I/O pad of the IC package.

In the usual mechanism to conduct the ESD current away is implementing an ESD circuit with the internal circuit which is to be protected from the ESD current/voltage. The ESD circuit is at the off state when no ESD event. However, when the ESD event occurs, the ESD circuit would be turn on to create a short trigger path, so that the ESD current/voltage would be conducted away without entering the internal circuit.

However, the ESD current/voltage may still a possibility in leaking to the internal circuit. How to improve the blocking capability from the ESD event for the internal circuit is still an issue in consideration for designing the ESD circuit.

### SUMMARY OF THE INVENTION

The invention provides ESD circuit and method to protect an internal circuit from ESD event. The ESD event may be efficiently blocked to the internal circuit to be protected.

In an embodiment, the invention provides an ESD circuit, which is used to protect an internal circuit. The ESD circuit includes: an ESD clamp, having a first terminal connected to a power and a second terminal connected to a ground voltage; and a first switch, connected between an ESD terminal of the ESD clamp and the internal circuit. A gate of the first switch is controlled by a state signal in the ESD clamp to turn off the first switch when an ESD event occurs on the first terminal of the ESD clamp and turn on the first switch when the ESD event does not occur.

In an embodiment, as to the ESD circuit, the first terminal and the ESD terminal are a same node.

In an embodiment, as to the ESD circuit, the ESD clamp comprises a resistor and a capacitor, connected in series between the first terminal and the second terminal. An inverter is connected between the first terminal and the second terminal, wherein the inverter has an input terminal connected to a connection node between the resistor and the capacitor. A second switch is connected between the first terminal and the second terminal, wherein the second switch is controlled by an output of the inverter. The gate of the first switch is connected to one of the input terminal and the output terminal of the inverter to receive the state signal. The first switch and the second switch are opposite in conduction state.

In an embodiment, as to the ESD circuit, the first switch is a P-type MOS (PMOS) transistor and the gate of the first switch is connected to the output terminal of the inverter.

In an embodiment, as to the ESD circuit, a bulk electrode of the PMOS transistor is connected to the first terminal of the ESD clamp.

In an embodiment, as to the ESD circuit, the first switch is an N-type MOS (NMOS) transistor and the gate of the first switch is connected to the input terminal of the inverter.

In an embodiment, as to the ESD circuit, a bulk electrode of the NMOS transistor is connected to the second terminal of the ESD clamp.

In an embodiment, as to the ESD circuit, the first terminal and the ESD terminal are different nodes, wherein the first terminal receives the power for operation of the ESD clamp and the ESD terminal receives an ESD signal when the ESD signal is induced.

In an embodiment, as to the ESD circuit, the ESD clamp comprises a resistor and a capacitor, connected in series between the first terminal and the second terminal. An inverter is connected between the first terminal and the second terminal, wherein the inverter has an input terminal connected to a connection node between the resistor and the capacitor. A second switch is connected between the first terminal and the second terminal, wherein the second switch is controlled by an output of the inverter. A diode string is connected between the first terminal and the second terminal, wherein a portion of the diode string is between the first terminal and the ESD terminal. The gate of the first switch is connected to one of the input terminal and the output terminal of the inverter to receive the state signal. The first switch and the second switch are opposite in conduction state.

In an embodiment, as to the ESD circuit, the first switch is a P-type MOS (PMOS) transistor and the gate of the first switch is connected to the output terminal of the inverter.

In an embodiment, as to the ESD circuit, a bulk electrode of the PMOS transistor is connected to the first terminal of the ESD clamp.

In an embodiment, as to the ESD circuit, the first switch is an N-type MOS (NMOS) transistor and the gate of the first switch is connected to the input terminal of the inverter.

In an embodiment, as to the ESD circuit, a bulk electrode of the NMOS transistor is connected to the second terminal of the ESD clamp.

In an embodiment, the invention also provides a method to protect an internal circuit from electrostatic discharge (ESD) current. The method comprises providing an ESD clamp, having a first terminal connected to a power and a second terminal connected to a ground voltage. In addition, a first switch is provided in connection between an ESD terminal of the ESD clamp and the internal circuit. A gate of the first switch is controlled by a state signal in the ESD clamp to turn off the first switch when an ESD event occurs on the first terminal of the ESD clamp and turn on the first switch when the ESD event does not occur.

In an embodiment, as to the method, the first terminal and the ESD terminal are configured to be a same node.

In an embodiment, as to the method, the ESD clamp as provided comprises a resistor and a capacitor, connected in series between the first terminal and the second terminal. In addition, an inverter is connected between the first terminal and the second terminal, wherein the inverter has an input terminal connected to a connection node between the resistor and the capacitor. A second switch is connected between the first terminal and the second terminal. The second switch is controlled by an output of the inverter. The gate of the first switch is connected to one of the input terminal and the output terminal of the inverter to receive the state signal. The first switch and the second switch are opposite in conduction state.

In an embodiment, as to the method, the first switch is a P-type MOS (PMOS) transistor and the gate of the first switch is connected to the output terminal of the inverter.

In an embodiment, as to the method, the first switch is an N-type MOS (NMOS) transistor and the gate of the first switch is connected to the input terminal of the inverter.

In an embodiment, as to the method, the first terminal and the ESD terminal configured to be different nodes, wherein the first terminal receives a power for operation of the ESD clamp and the ESD terminal receives an ESD signal when the ESD signal is induced.

In an embodiment, as to the method, the ESD clamp as provided comprises a resistor and a capacitor, connected in series between the first terminal and the second terminal. In addition, an inverter is connected between the first terminal and the second terminal, wherein the inverter has an input terminal connected to a connection node between the resistor and the capacitor. A second switch is connected between the first terminal and the second terminal, wherein the second switch is controlled by an output of the inverter. a diode string is connected between the first terminal and the second terminal, wherein a portion of the diode string is between the first terminal and the ESD terminal. The gate of the first switch is connected to one of the input terminal and the output terminal of the inverter to receive the state signal. The first switch and the second switch are opposite in conduction state.

### BRIEF DESCRIPTION OF THE DRAWINGS

In order to make the aforementioned and other objectives and advantages of the present invention comprehensible, embodiments accompanied with figures are described in detail below.

FIG. 1 is a drawing, schematically illustrating an ESD circuit as looked into, according to a prior art.

FIG. 2 is a drawing, schematically illustrating an ESD circuit suffering the ESD event, according to an embodiment of the invention.

FIG. 3 is a drawing, schematically illustrating an ESD circuit without suffering the ESD event, according to an embodiment of the invention.

FIG. 4A is a drawing, schematically illustrating an ESD circuit suffering the ESD event, according to an embodiment of the invention.

FIG. 4B is a drawing, schematically illustrating an ESD circuit without suffering the ESD event, according to an embodiment of the invention.

FIG. 5A is a drawing, schematically illustrating an ESD circuit suffering the ESD event, according to an embodiment of the invention.

FIG. 5B is a drawing, schematically illustrating an ESD circuit without suffering the ESD event, according to an embodiment of the invention.

FIG. 6A is a drawing, schematically illustrating an ESD circuit suffering the ESD event, according to an embodiment of the invention.

FIG. 6B is a drawing, schematically illustrating an ESD circuit without suffering the ESD event, according to an embodiment of the invention.

FIG. 7A is a drawing, schematically illustrating an ESD circuit suffering the ESD event, according to an embodiment of the invention.

FIG. 7B is a drawing, schematically illustrating an ESD circuit without suffering the ESD event, according to an embodiment of the invention.

### DESCRIPTION OF THE EMBODIMENTS

The invention is directed to the ESD protection technology, in which the ESD circuit is proposed to efficiently protect the internal circuit from the ESD event with improved blocking capability.

Several embodiments are provided for describing the invention but the invention is not just limited to the embodiments. In addition, a combination between the embodiments may be made for another embodiment.

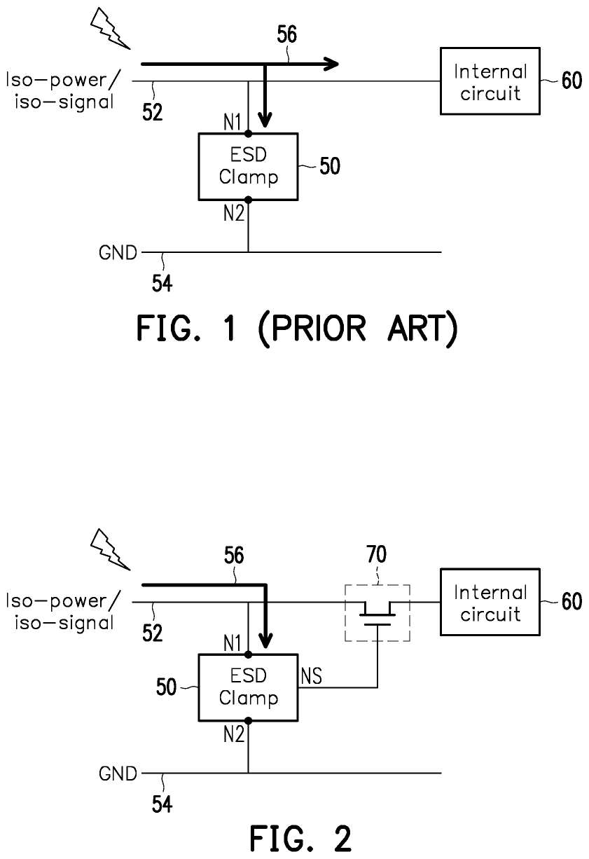

Referring to FIG. 1, the ESD event usually introduce a large ESD current or rather high ESD voltage, which consequently also cause the large current. When the ESD event accidently enters the internal application circuit, the internal application circuit may be damaged by this ESD event. The ESD circuit is used to quickly conduct the ESD event to the ground. As a result, the ESD circuit is prevented to enter the internal application circuit.

The design of the ESD circuit would determine the ESD protection capability. To improve the ESD protection capability, the invention has firstly looked into the protection mechanism of the ESD circuit and then provide an improved design of the ESD circuit.

FIG. 1 is a drawing, schematically illustrating an ESD circuit as looked into, according to a prior art. Referring to FIG. 1, an ESD clamp 50 has a terminal N1, connected to an internal circuit 60 to be protected. The ESD clamp 50 has another terminal N2 is connected to the ground (GND) 54. An ESD event 52 such as an isolated power (iso-power) or isolated signal (iso-signal) form may occur at the terminal N1 and introduce the ESD current 56 in an example.

In a usual way, the internal circuit 60 is also connected to the terminal N1 of the ESD clamp 50. The ESD current 56 would trigger the ESD clamp 50 as a conducting state, so that the ESD clamp 50 as conducted provides a path like a short trigger path to the ground 54. The ESD current 56 would be quickly drawn to the ground 54 without entering to the internal circuit 60.

However, if the ESD clamp 50 may be not sufficiently turned on in time due to the response time of the ESD clamp 50. The ESD current 56 may still leak to the internal circuit 60, and still causing damage to the internal circuit 60.

After looking into the protection mechanism of the ESD clap 50, the invention has proposed an ESD circuit to have more capability to protect the internal circuit from the ESD event. FIG. 2 is a drawing, schematically illustrating an ESD circuit suffering the ESD event, according to an embodiment of the invention.

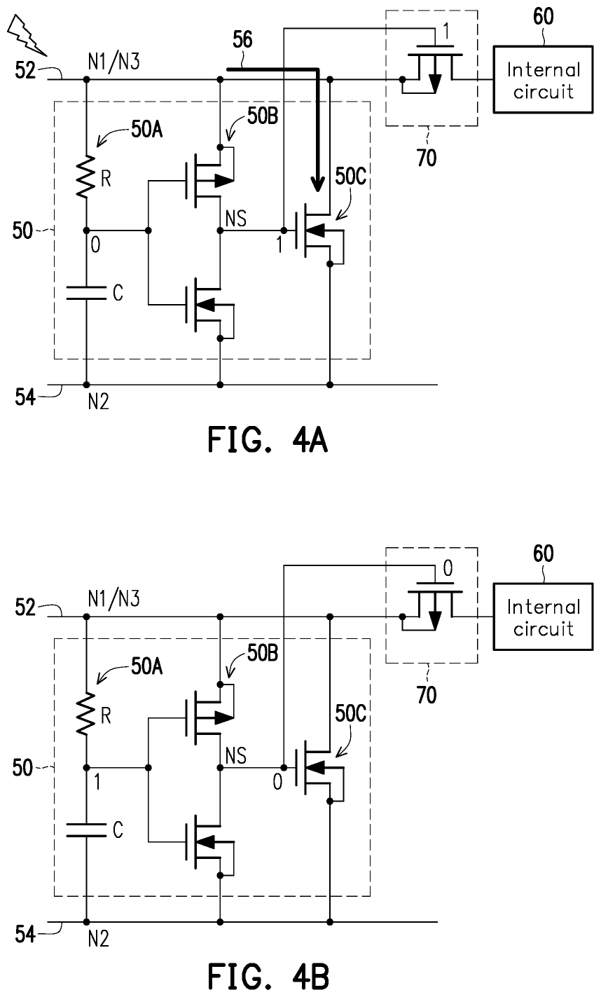

Referring to FIG. 2, as view from ESD circuit in FIG. 1, a switch 70 is additionally implemented between the terminal N1 of the ESD clamp 50 and the internal circuit 60. The switch 70 in an embodiment may be a transistor switch. The switch 70 such as the gate of the transistor switch is controlled for turning on or off by a state signal NS from ESD clamp 50, which is located at an ESD terminal N3 (see FIG. 4A) inside the ESD clamp 50 to provide the status of the ESD event, as to be described in detail. The switch 70 is turned off at a dis-conducted state when the ESD current 56 in an example is induced to the terminal N1. At this moment, the ESD clamp 50 is at the conduction state to conduct the ESD current 56 to the ground 54.

With the effect of the switch 70, the ESD current 56 may be more efficiently blocked to the internal circuit 60, in which the double protection of the ESD circuit is set up.

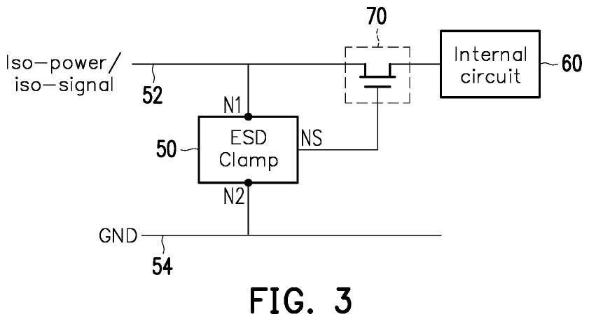

FIG. 3 is a drawing, schematically illustrating an ESD circuit without suffering the ESD event, according to an embodiment of the invention. Referring to FIG. 3, in a normal operation, no ESD event occurs, in which the switch 70 is turned on at the conduction state. The internal circuit 60 may have the usual connection as designed, such as receiving the system power in an example or an I/O terminal, not the ESD voltage. The system power may also provide the power to operate the ESD clamp 50.

The ESD clamp 50 in an embodiment may include a circuit structure, and the state signal NS may be provided from an ESD terminal of the ESD clamp 50 to obtain the status of the ESD event.

FIG. 4A is a drawing, schematically illustrating an ESD circuit suffering the ESD event, according to an embodiment of the invention. Referring to FIG. 4A, the ESD clamp 50 in an embodiment is shown in detail. In addition, the switch 70 is a P-type metal-oxide-semiconductor (PMOS) transistor in an example.

The ESD clamp 50 includes a trigger path 50A, an inverter path 50B, and a switch path 50C, which paths are parallel connection between the terminal N1 and the terminal N2. The trigger path 50A includes a resistor R and a capacitor C in series connection between the terminal N1 and the terminal N2. Here, the ESD terminal N3, where the ESD event may occur, is the same as the terminal N1, which may provide the usual power in operation. The inverter path 50B in an example includes an inverter as formed by two transistors as usually taken. The switch path 50C in an example is another transistor switch, which is an N-type metal-oxide-semiconductor (NMOS) transistor. The bulk electrode of the connected to the ground 54 at the terminal N2. The switch 70 in an embodiment may be PMOS transistor, of which the bulk electrode is connected to the terminal N1.

The inverter of the inverter path 50B has an input terminal connected to the connection node between the resistor R and the capacitor C in the trigger path 50A. The inverter of the inverter path 50B also has an output terminal to control the gate of the NMOS transistor of the switch path 50C. The switch 70 is connected between the terminal N1 and the internal circuit 60.

In an embodiment, the ESD current 56 would accidently enter the ESD terminal N3, which is the same as the terminal N1. The protection mechanism is following. The ESD event may refer to the ESD current (voltage) 56 in an example. The ESD event usually is an AC signal with high frequency. Due to the RC effect in the trigger path 50A, the capacitor C is operating as a short element to the ground 54. As a result, the input terminal of the inverter of the inverter path 50B has a low state as indicated by “0”, corresponding to the ground 54. The inverter path 50B inverts the low state of “0” to the high state of “1” at the output terminal. The states signal NS is at the output terminal of the inverter path 50B, then the states signal NS has the high state of “1”, which turns on the switch path 50C, operated as a short circuit to the ground 54.

Further, the states signal NS with the high state of “1” also controls the switch 70 to be turned off. In an example, the switch 70 as the PMOS transistor is different conductive type from the NMOS transistor of the switch path 50C. The states signal NS with the high state of “1” would turn off the switch 70 to additionally block the ESD current 56 to the internal circuit 60. As a result, the internal circuit 60 has more ESD protection effect from the ESD current 56.

FIG. 4B is a drawing, schematically illustrating an ESD circuit without suffering the ESD event, according to an embodiment of the invention. Referring to FIG. 4B, when no ESD even occurring in a normal operation, the iso-power provides the DC power to the trigger path 50A, in which the capacitor C with the RC effect is operating as a disconnect element to the ground 54 and then provides the input terminal of the inverter path 50B by the high state of “1”, corresponding to the iso-power at the terminal N1. Due to the inverter path 50B, the state signal NS is at the low state of “0”. The switch path 50C is turned off by the state signal NS. However, the switch 70 as controlled by the state signal NS is at the conduction state in this normal operation.

With the similar mechanism, the switch 70 may be implemented by the NMOS transistor. Then, the state signal NS would be taken from the input terminal of the inverter.

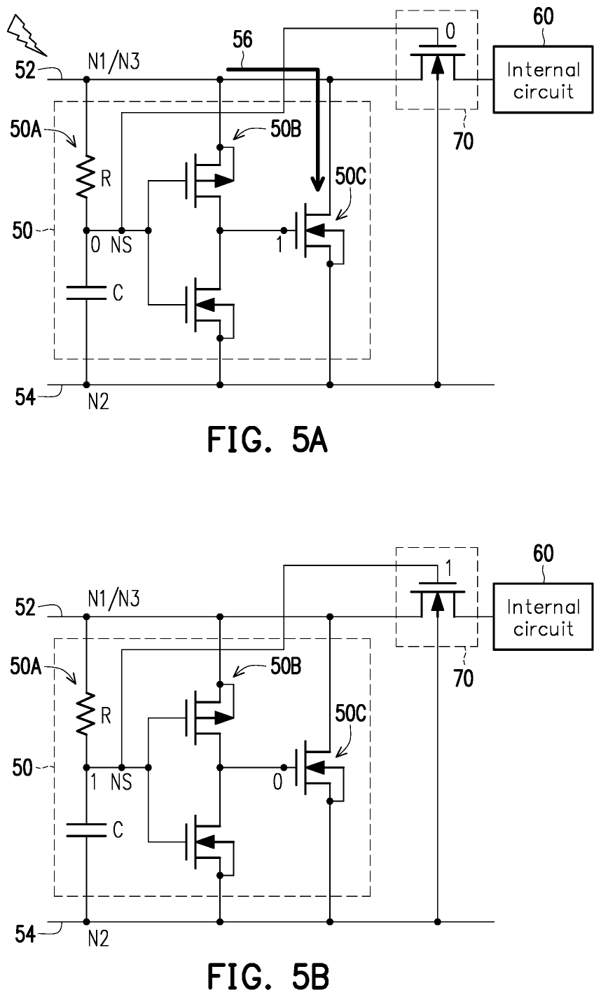

FIG. 5A is a drawing, schematically illustrating an ESD circuit suffering the ESD event, according to an embodiment of the invention. Referring to FIG. 5A, the switch 70 in an embodiment is implemented by a NMOS transistor. Based on the conduction property of the NMOS transistor, the gate for receiving the state signal NS is connected to the input terminal of the inverter of the inverter path 50B. As result, when the ESD current 56 occurs, the state signal NS of low state “0” is used to turn off the NMOS transistor of the switch 70. Here, the bulk electrode of the NMOS transistor is connected to the ground 54. The ESD protection of the ESD clamp 50 is the same as FIG. 4A.

FIG. 5B is a drawing, schematically illustrating an ESD circuit without suffering the ESD event, according to an embodiment of the invention. Referring to FIG. 5B, when no ESD event occurring, the state signal NS is at the high state “1”. The ESD protection of the ESD clamp 50 is the same as FIG. 4B at the normal operation. The switch 70 is turn on to the conduction state.

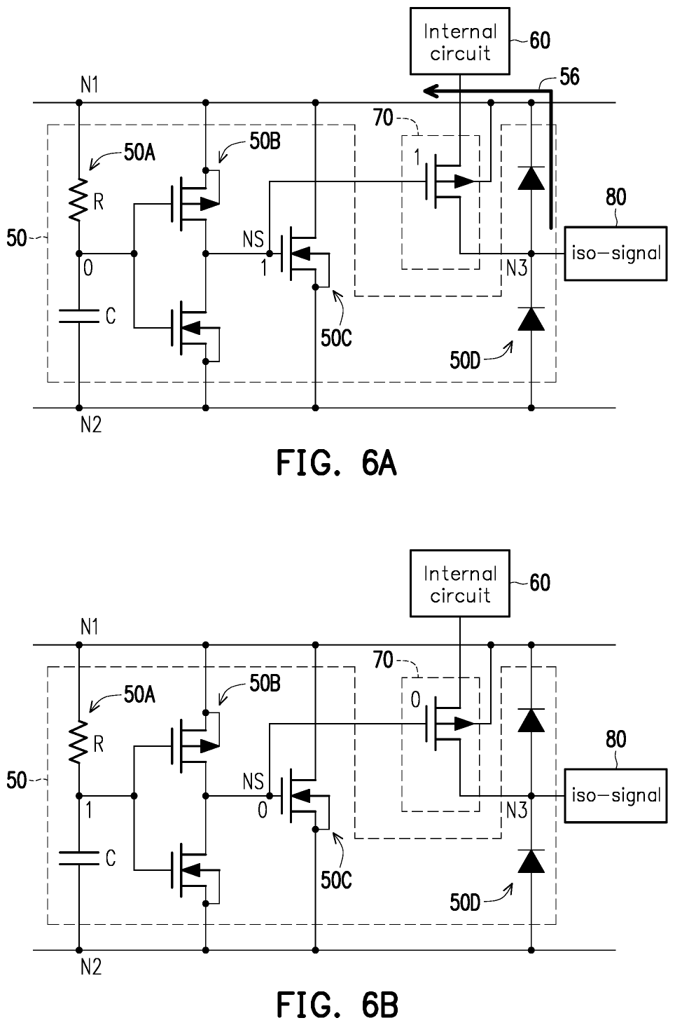

In a further example, the ESD event may not occur at the terminal N1. FIG. 6A is a drawing, schematically illustrating an ESD circuit suffering the ESD event, according to an embodiment of the invention.

Referring to FIG. 6A, the internal circuit 60 may receive signal source as indicated by iso-signal 80 as an example. Then, the ESD terminal N3 of the ESD clamp 50 may suffering the ESD current 56 from the ESD event. In this ESD protection, the ESD clamp 50 may further includes a diode path 50D, which is a diode string in an example. The iso-signal 80 is connected to the diode path 50D at the ESD terminal N3, where the ESD current 56 may enter.

The switch 70 is a PMOS transistor as an example similar to the switch 70 in FIG. 4A. In this situation, the terminal N1 receives the power for operation of the ESD clamp 50. Although the ESD terminal is not identical to the terminal N1, the ESD current 56 still flows to the terminal N1 through a portion of the diode string in the diode path 50D. The ESD protection mechanism is similar to FIG. 4A as the foregoing description. The state signal NS with the high state of “1” would turn off the switch 70, so as to block the ESD current 56 to enter the internal circuit 60.

FIG. 6B is a drawing, schematically illustrating an ESD circuit without suffering the ESD event, according to an embodiment of the invention. Referring to FIG. 6B, similar to FIG. 4B, the ESD current 56 in FIG. 6A is not introduced as the normal operation. The output of the inverter of the inverter path 50B provides the state signal NS by the low state of “0”. The state signal NS by the low state of “0” turn off the switch path 50C but turn on the switch 70 of the PMOS transistor.

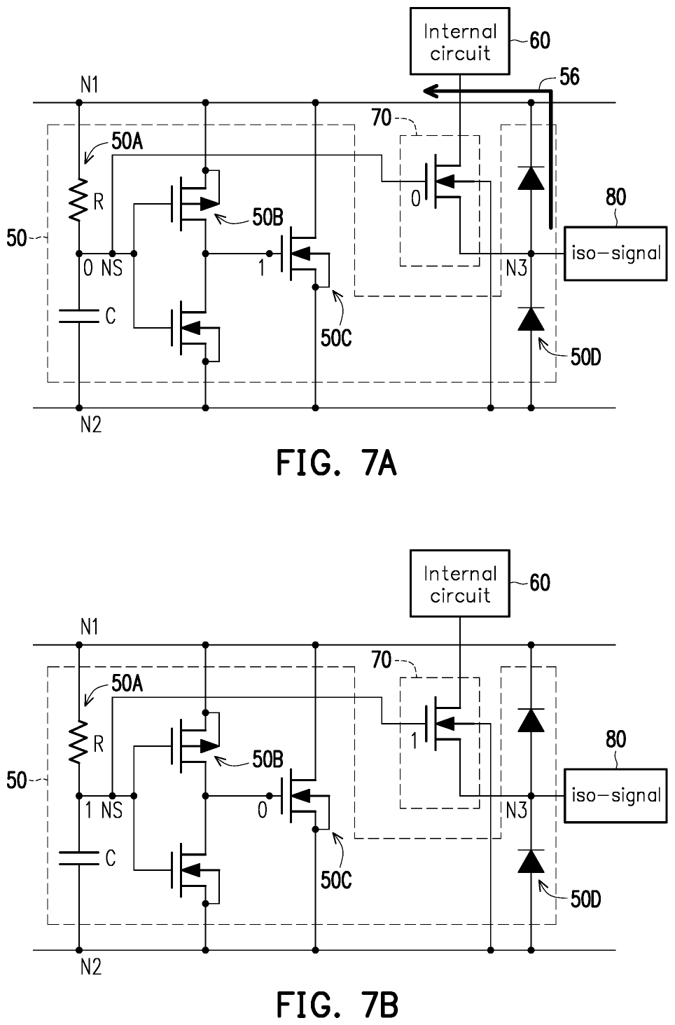

Likewise, the switch 70 based on the ESD circuit in FIG. 6A may be implemented by the NMOS transistor, instead. FIG. 7A is a drawing, schematically illustrating an ESD circuit suffering the ESD event, according to an embodiment of the invention.

Referring to FIG. 7A, similar to the FIG. 5A, the switch 70 is changed to the NMOS transistor. Due to the different conduction mechanism for the NMOS transistor, the gate of the NMOS transistor of the switch 70 is controlled by the state signal NS from the input terminal of the inverter path 50B. When the ESD current 56 occur, the trigger path 50A provide the state signal NS by a low state of “0”, which turns off the switch 70.

FIG. 7B is a drawing, schematically illustrating an ESD circuit without suffering the ESD event, according to an embodiment of the invention. Referring to FIG. 7B, when no ESD event occurs, the state signal NS is at the high state of “1”, which also turn on the switch 70 ate the normal operation.

In the foregoing description, the ESD circuit include the switch 70 which is control by the state signal NS, as obtained from the ESD clamp 50. Depending on the conductive type of the switch 70 in PMOS or NMOS, the input terminal or the output terminal of the inverter path 50B may provide the state signal NS. The ESD terminal N3 may be the same as the power terminal N1 or a signal terminal to the internal circuit 60.

Further as to a method to protect an internal circuit from electrostatic discharge current. The method in an embodiment may include providing an ESD clamp 50, having a first terminal N1 connected to a power and a second terminal N2 connected to a ground voltage, GND. In addition, a first switch 70 is provided in connection between an ESD terminal N3 of the ESD clamp 50 and the internal circuit 60. A gate of the first switch 70 is controlled by a state signal NS in the ESD clamp 50 to turn off the first switch 70 when an ESD current 56 occurs on the first terminal N1 of the ESD clamp 50 and turn on the first switch 70 when the ESD current 56 does not occur.

Although the invention is described with reference to the above embodiments, the embodiments are not intended to limit the invention. A person of ordinary skill in the art may make variations and modifications without departing from the spirit and scope of the invention. Therefore, the protection scope of the invention should be subject to the appended claims.

What is claimed is:

1. An electrostatic discharge (ESD) circuit, to protect an internal circuit, the ESD circuit comprising:
an ESD clamp, having a first terminal connected to a power and a second terminal connected to a ground voltage; and
a first switch, connected between an ESD terminal of the ESD clamp and the internal circuit,
wherein a gate of the first switch is controlled by a state signal in the ESD clamp to turn off the first switch when an ESD event occurs on the first terminal of the ESD clamp and turn on the first switch when the ESD event does not occur.

2. The ESD circuit of claim 1, wherein the first terminal and the ESD terminal are different nodes, wherein the first terminal receives the power for operation of the ESD clamp and the ESD terminal receives an ESD signal when the ESD signal is induced, wherein the power is an isolated power.

3. The ESD circuit of claim 2, wherein the ESD clamp comprises:
a resistor and a capacitor, connected in series between the first terminal and the second terminal;
an inverter, connected between the first terminal and the second terminal, wherein the inverter has an input terminal connected to a connection node between the resistor and the capacitor;
a second switch, connected between the first terminal and the second terminal, wherein the second switch is controlled by an output of the inverter; and
a diode string, connected between the first terminal and the second terminal, wherein a portion of the diode string is between the first terminal and the ESD terminal,
wherein the gate of the first switch is connected to one of the input terminal and the output terminal of the inverter to receive the state signal,
wherein the first switch and the second switch are opposite in conduction state.

4. The ESD circuit of claim 3, wherein the first switch is a P-type MOS (PMOS) transistor and the gate of the first switch is connected to the output terminal of the inverter.

5. The ESD circuit of claim 4, wherein a bulk electrode of the PMOS transistor is connected to the first terminal of the ESD clamp.

6. The ESD circuit of claim 3, wherein the first switch is an N-type MOS (NMOS) transistor and the gate of the first switch is connected to the input terminal of the inverter.

7. The ESD circuit of claim 6, wherein a bulk electrode of the NMOS transistor is connected to the second terminal of the ESD clamp.

8. A method to protect an internal circuit from electrostatic discharge (ESD) current, comprising:
providing an ESD clamp, having a first terminal connected to a power and a second terminal connected to a ground voltage; and
providing a first switch, connected between an ESD terminal of the ESD clamp and the internal circuit,
wherein a gate of the first switch is controlled by a state signal in the ESD clamp to turn off the first switch when an ESD event occurs on the first terminal of the ESD clamp and turn on the first switch when the ESD event does not occur.

9. The method of claim 8, wherein the first terminal and the ESD terminal configured to be different nodes, wherein the first terminal receives a power for operation of the ESD clamp and the ESD terminal receives an ESD signal when the ESD signal is induced, wherein the power is an isolated power.

10. The method of claim 9, wherein the ESD clamp as provided comprises:
a resistor and a capacitor, connected in series between the first terminal and the second terminal;
an inverter, connected between the first terminal and the second terminal, wherein the inverter has an input terminal connected to a connection node between the resistor and the capacitor;
a second switch, connected between the first terminal and the second terminal, wherein the second switch is controlled by an output of the inverter; and
a diode string, connected between the first terminal and the second terminal, wherein a portion of the diode string is between the first terminal and the ESD terminal,
wherein the gate of the first switch is connected to one of the input terminal and the output terminal of the inverter to receive the state signal,
wherein the first switch and the second switch are opposite in conduction state.
